(19) United States
(12) Patent Application Publication
(10) Pub. No.: US 2012/0086941 A1
(43) Pub. Date: Apr. 12, 2012

(54) Vehicular Headlight Adjustment Apparatus And Method of Use

(76) Inventor: RHODY HAYES, Pasco, WA (US)

(21) Appl. No.: 12/901,502

(22) Filed: Oct. 9, 2010

(51) Int. Cl. G01B 11/00

(52) U.S. Cl. 356/399

(57) ABSTRACT

Disclosed and claimed herein is an apparatus for the alignment of headlight beams and the method of use of the apparatus. A headlight alignment stand (100) positions one or more alignment panels (200) for level calibration of the apparatus and for calibration of one or more vehicle headlights.

### FIELD OF THE INVENTION

The present invention generally relates the adjustment of the focus of a light or lamp, and more particularly to the adjustment of vehicular and automobile headlights.

### BACKGROUND OF THE INVENTION

Devices to physically rotate a headlight are known including U.S. Pat. No. 5,285,360 to Kanner and U.S. Pat. No. 5,779,343 to Denley. Devices to guide the amount or degree of headlight rotation or adjustment, vertically and horizontally, are known including U.S. Pat. No. 2,314,559 to Schilling; U.S. Pat. No. 6,183,118 to Toda et al; U.S. Pat. No. 6,573,860 to Winter et al; Snap-on Equipment-Cartec-PLA 20-DR-LET-Professional Headlight adjusting device; American Aimers Hoppy v25 and v100 (Hoppy systems may have a track in the floor, requiring a dedicated stall, and use an optical device); Canbuilt OPT 5405.

The patents and publications referred to herein are provided herewith in an Information Disclosure Statement in accordance with 37 CFR 1.97.

### SUMMARY OF THE INVENTION

Disclosed and claimed herein is an apparatus for the alignment of headlight beams and the method of use of the apparatus. A headlight alignment stand (100) positions one or more alignment panels (200) for calibration of the apparatus relative to the levelness of the surface on which the vehicle rests and for calibration or adjustment of one or more vehicle headlights.

### BRIEF DESCRIPTION OF THE FIGURES

The foregoing and other features and advantages of the present invention will become more readily appreciated as the same become better understood by reference to the following detailed description of the preferred embodiment of the invention when taken in conjunction with the accompanying drawings, wherein:

FIGS. 1, 2, 3 and 4 illustrate the headlight alignment stand (100) showing a stand upright member (120), a stand cross member (140), a stand base member (160), tube bushings (180), casters (190), panels (200), panel and laser support brackets (210), panel and laser support bracket tubes (212), panel bracket attachments (215), panel calibration lines (220), panel laser apertures (240), a laser system (300), lasers (360), laser power supply (380) and laser power cable (384).

FIGS. 5 and 6 illustrate the laser system 300 showing the laser bracket system (310), laser vertical adjustment knob/bolt (320), laser vertical adjustment bolt nut (322), laser vertical adjustment slot (324), laser vertical adjustment pivot (326), laser vertical adjustment aperture (328), laser horizontal adjustment aperture (340), laser horizontal adjustment bolt/nut (344), laser (360), laser bracket aperture (364), laser bracket (368) and laser power cable (384).

FIGS. 7 and 8 show the panels (200), panel and laser support bracket (210), panel and laser support bracket tube (212), panel bracket attachment (215), panel bracket rivet apertures (217), panel laser aperture (240), laser system (300), laser bracket system (310), laser adjustment handle (315), laser vertical adjustment knob/bolt (320), laser vertical adjustment bolt nut (322), laser vertical adjustment slot (324), laser vertical adjustment pivot (326), laser vertical adjustment aperture (328), laser horizontal adjustment aperture (340), laser horizontal adjustment bolt/nut (344), laser (360), laser bracket aperture (364) and laser bracket (368).

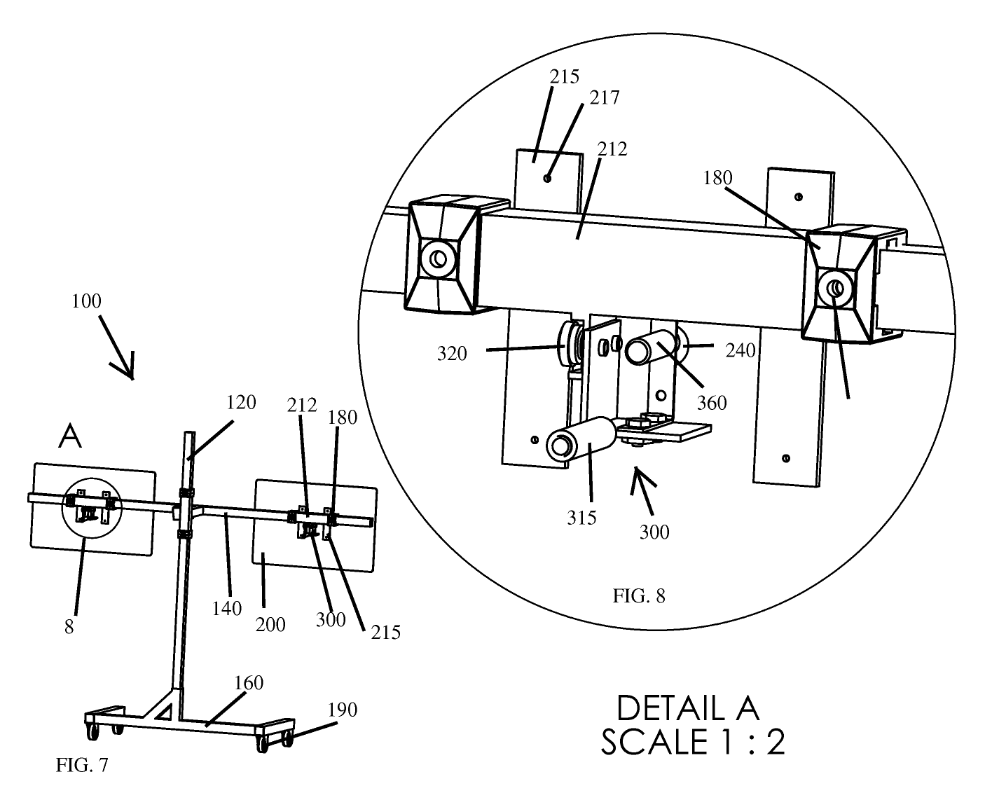

FIGS. 9, 10, 11, 12 and 13 illustrate the tube bushing (180) showing the tube fitting aperture and threaded insert (185), tube busing first edge (187) and tube bushing second edge (189).

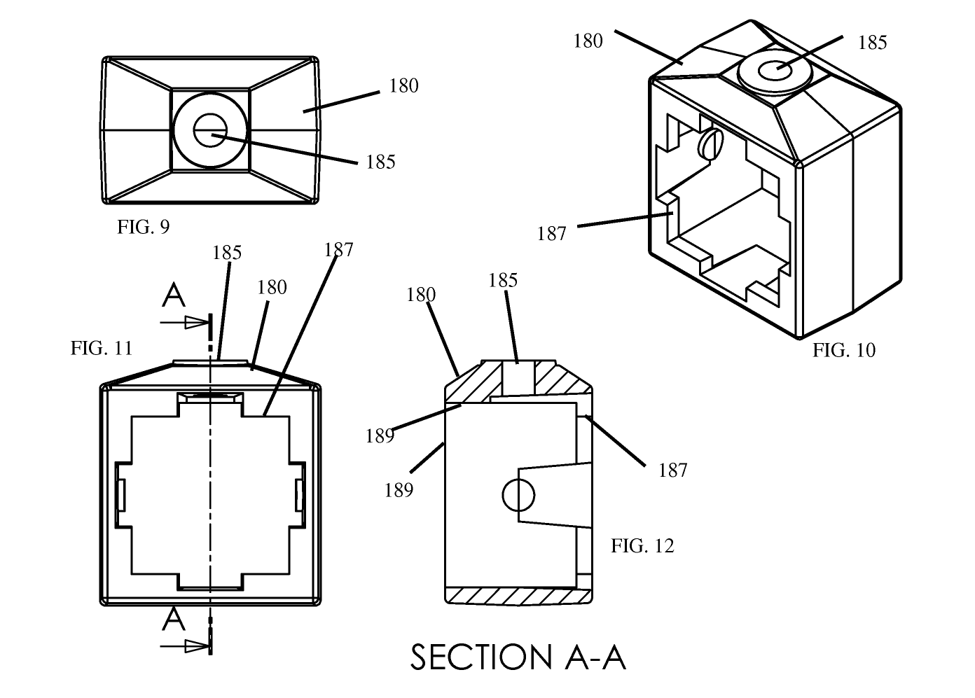

FIG. 14 shows a headlight alignment stand (100) with a stand upright member (120), a stand base member (160), a panel (200), panel and laser support bracket tube (212) , panel calibration lines (220), a panel laser aperture (240), and tube bushings (180).

FIGS. 15, 16 and 17 illustrate a vehicle (400), a vehicle axis (405), tires (410), headlights (415), headlight axis (420), level calibration devices (500) including a front level calibration device (510) and a rear level calibration device (520) having level calibration line (540) and level calibration device stands (560). Also seen is the headlight alignment stand (100) proximal the vehicle (400) with the panel (200), laser (360) and laser beam (387) in position for laser beam level calibration (390). Also illustrated are level calibration devices (500) showing a front level calibration device (510) and a rear level calibration device (520).

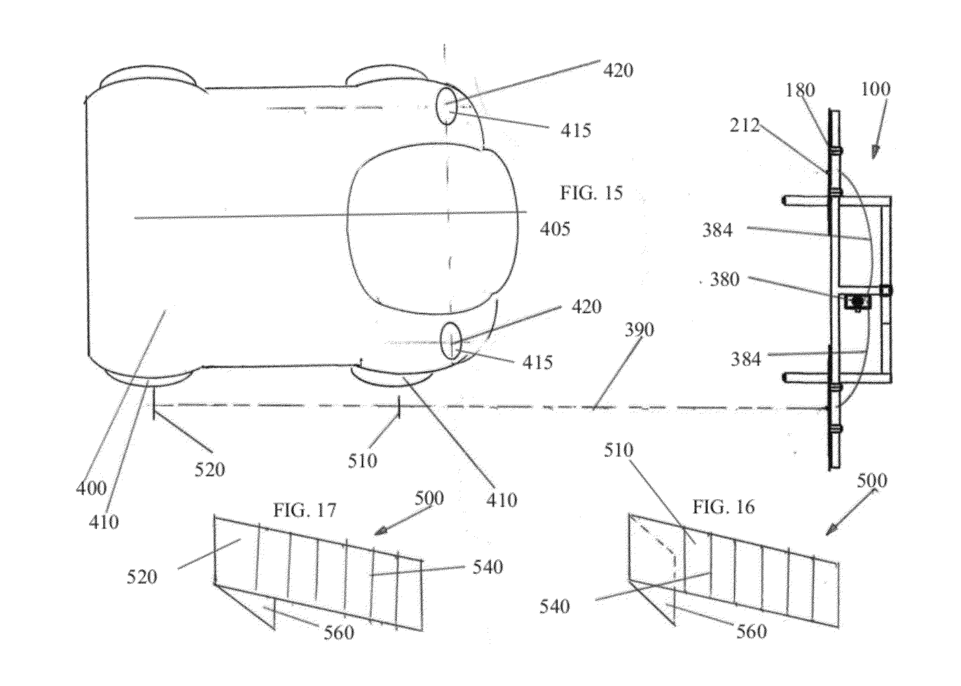

FIG. 18 shows the headlight alignment stand (100) with panels (200) and panel and laser support brackets (210) proximal headlights (415) with the laser beam (387) co-incident with the headlight axis (420). Also seen is a vehicle axis (405).

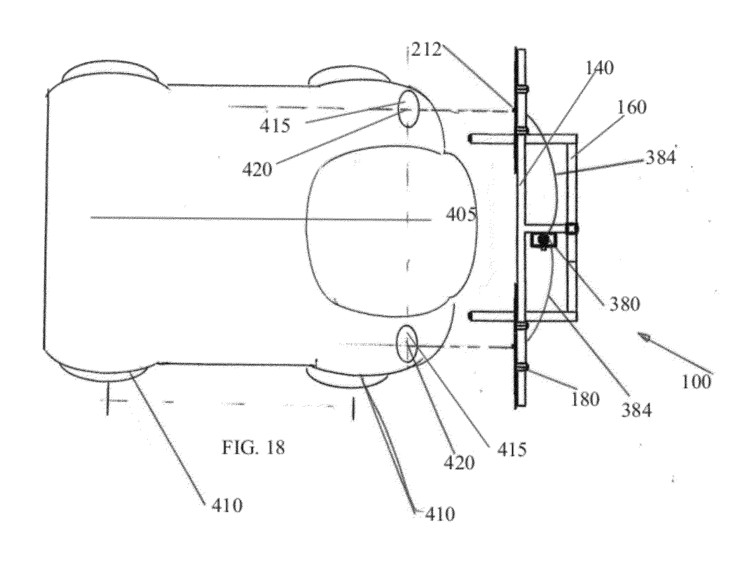

FIG. 19 shows the headlight alignment stand (100) positioned distal from the vehicle (400) at a headlight calibration distance (430) from the vehicle (430).

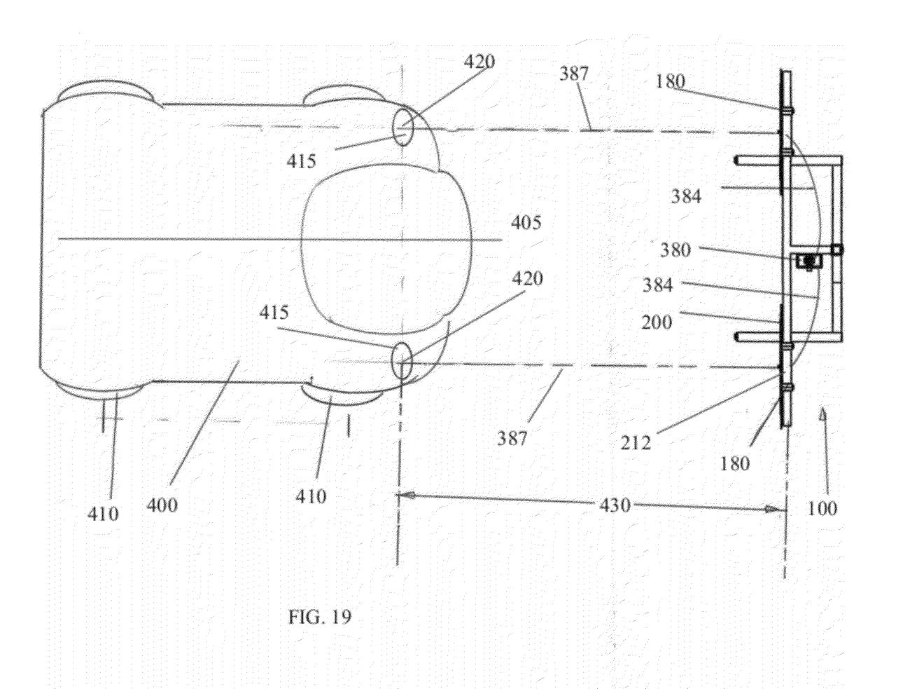

### DETAILED DESCRIPTION OF THE INVENTION

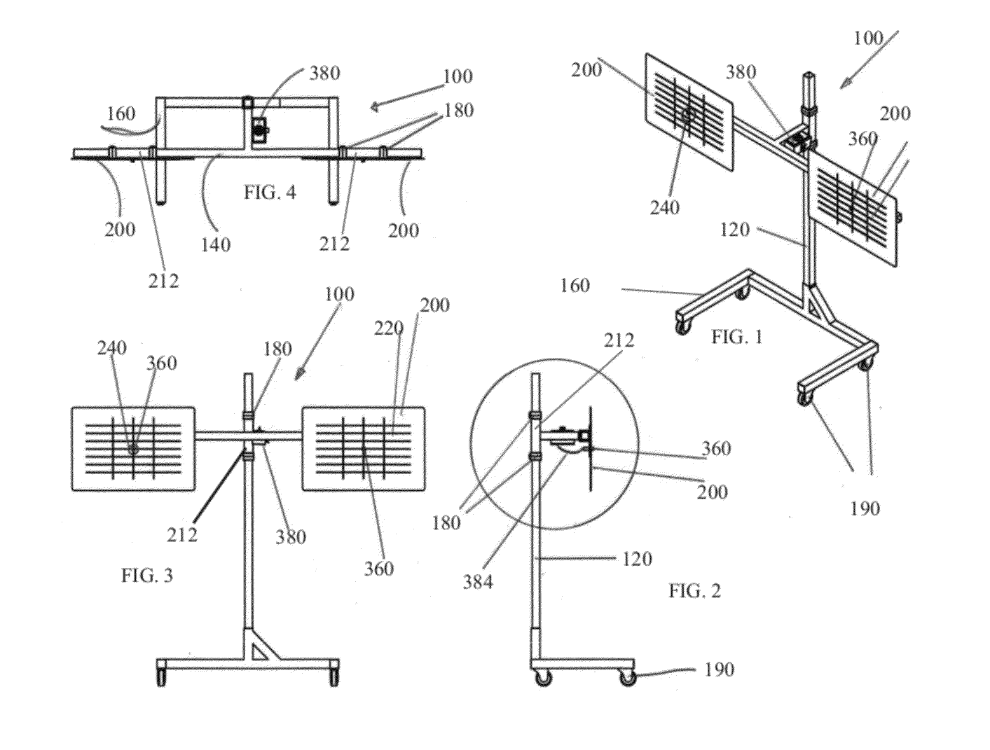

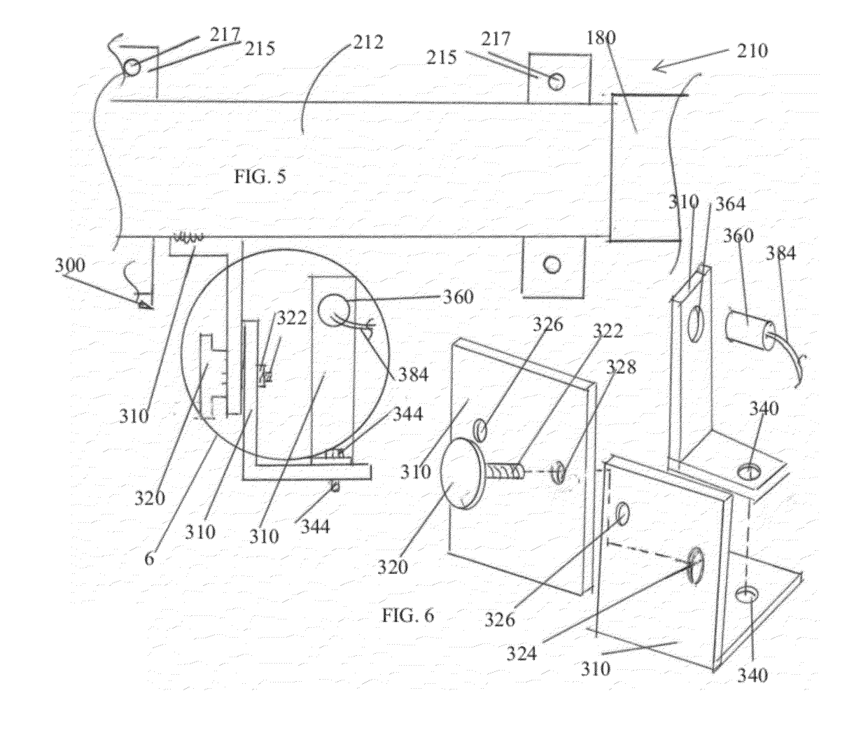

The preferred embodiment of the apparatus this disclosure is seen in FIGS. 1 through 6 illustrating the headlight alignment stand (100) composed primarily of rigid tubular materials including metals and plastics. A stand upright member (120), a stand cross member (140) and a stand base member (160) are principally composed of square metal tubing interconnected generally by welding. The stand cross member (140) is movably affixed to the stand upright member (120) by use of a slidable panel and laser support bracket tube (212) with at least one tube bushing (180) as seen in FIGS. 1, 2 and 3. Those of ordinary skill in the tube connecting arts will appreciate that such structures can be interconnected with other means including screw, bolt/nut and other methods.

Also seen in FIG. 1 through 6 is at least one panel (200) mounted, generally by rivets, to a panel and laser support bracket (210). The panel and laser support bracket (210) comprises, in part, a panel and laser support bracket tube (212) which is sized to receive either a stand upright member (120) or a stand cross member (140). Circular or square/rectangular cross-section tubing may be employed in the construction of the headlight alignment stand (100), however, it will be appreciated that a square or rectangular cross-section tube will resist rotation of a panel and laser support bracket (210).

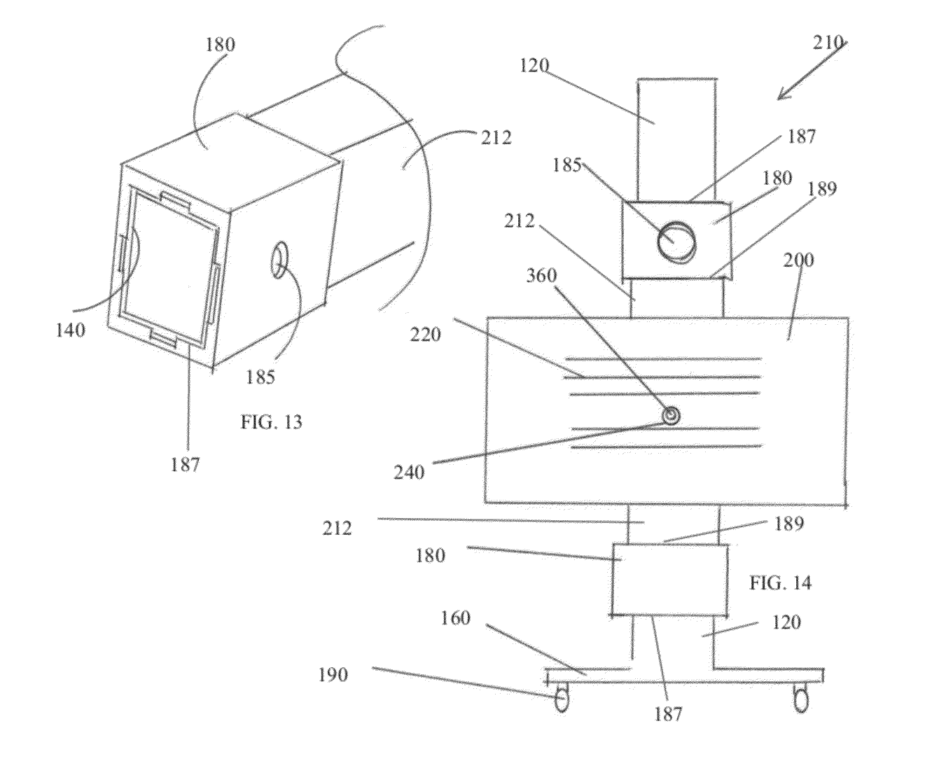

FIG. 14 illustrates an alternative embodiment of the headlight alignment stand (100) having a stand upright member (120), a panel (200), panel and laser support bracket (210) and laser (360). This alternative embodiment may be used when adjusting the headlight on a motorcycle.

In each embodiment of the headlight alignment stand (100) casters (190) may be used for mobility.

A tube bushing (180), generally composed of plastic and formed in a molding process, is shaped and sized, at a tube bushing second edge (189), to be pressed or friction fit to the panel and laser support bracket tube (212). The shape at the tube bushing second edge (189) matches the shape of the panel and laser support bracket tube (212). The stand upright member (120) or stand cross member (140) slides into the panel and laser support bracket tube (212). The tube bushing (180), at a tube bushing first edge (187), is shaped and sized to friction secure the panel and laser support bracket (210) while allowing the panel and laser support bracket (210) to be slid horizontally or vertically to a new desired position. The shape of the tube bushing (180) at the tube bushing first edge (187) is irregular, as seen in FIG. 10, having a shape which eliminates contact between the tube bushing first edge (187) uniformly with the stand upright member (120) or stand cross member (140) to which it is attached. The irregularity of the tube bushing first edge (187) lessens the likelihood that the tube bushing (180) will inhibit the ability to slide the panel and laser support bracket (210) while maintaining sufficient friction to retain the position of the panel and laser support bracket (210). However, the figures also show the tube bushing (180) to have a tube bushing aperture and threaded insert (185) which can threadedly receive a bolt to cause the tube bushing (180) to be immovably fixed in position.

FIG. 1 through 6 also show at least one alignment panel (200) immovably affixed by rivet means to the panel and laser support bracket (210) and a laser system (300) immovably affixed by affixing means to the panel and laser support bracket (210). In the preferred embodiment the panel (200) is elongated and flat and is attached to the panel and laser support bracket (210) by panel bracket attachment (215) generally via rivets through at least one panel bracket rivet aperture (217). Panel calibration lines (220) appear on the panel (200) facing the vehicle when the adjustment is made.

The laser system is comprised of a laser (360) moveably affixed, for horizontal and vertical adjustment, and positioned to direct a laser beam (387), through a panel laser aperture (240) in said panel (200), primarily orthogonal to the panel (200). An adjustment required by the inclination of the surface on which the vehicle rests is realized by use of a front level calibration device (510) positioned proximal a front vehicle wheel (410) and a rear level calibration device (520) positioned proximal a rear vehicle wheel (410). A preferred embodiment of the front level calibration device (510) is upstanding and composed of transparent material, including plastics, bearing at least one level calibration line (540) and supported by a level calibration device stand (560). A preferred embodiment of the rear level calibration device (520) is upstanding and composed of opaque, including plastics, bearing at least one level calibration line (540) and supported by a level calibration device stand (560). Adjustment for the inclination of the surface is accomplished by the headlight alignment stand (100) being positioned proximal a vehicle (400) thereby positioning the panel primarily orthogonal to a vehicle axis (405), generally from vehicle center front to center rear, and aligning the laser (360) and laser beam (387) with the front level calibration device (510) and with the rear level calibration device (520). The front level calibration device (510) and the rear level calibration device (520) are primarily parallel to the vehicle axis (405) and each have at least one level calibration line (540) equally positioned. The laser (360) and laser beam (387) is position adjusted to contact the at least one level calibration line (540) on both the front level calibration device (510) and the rear level calibration device (520).

Laser (360) vertical or horizontal adjustment is accomplished by the laser bracket system (310) which comprises brackets including “L” brackets which position the laser (360) to present a laser beam (387) through a panel laser aperture (240). A laser vertical adjustment knob/bolt (320) is inserted into a laser horizontal adjustment aperture (340) and then into a vertical adjustment slot (324) and secured by a laser vertical adjustment bolt nut (322). Vertical movement of the laser (360) is accomplished by loosening the laser vertical adjustment knob/bolt (320) and pivoting the “L” bracket about a laser vertical adjustment pivot (326) comprised of a bolt/nut through laser vertical adjustment pivot (326) apertures in the “L” bracket. A horizontal adjustment is made by “L” bracket interconnection with a laser horizontal adjustment bolt/nut (344) with horizontal movement made by loosening the adjustment bolt/nut (344) and rotating the laser (360). The laser (360) is affixed at the “L” bracket through a laser bracket aperture (364) by laser affixing means usually made by nut/thread connection. Seen in FIG. 8 is a laser adjustment handle (315) for use in “L” bracket rotation for horizontal and vertical adjustment of the laser beam (387). Upon adjustment of the laser beam (387), the laser (360) is temporarily immovably fixed, by laser (360) position fixing means usually by tightening bolts including the laser vertical adjustment knob/bolt (320) and or the laser horizontal adjustment bolt/nut (344).

The figures show a 9 v laser power supply (380) affixed to the headlight alignment stand (100) with laser power cables (384) connecting with the at least one laser (360). Power of the laser power supply (380) is with a single 9 v battery.

With the leveling adjustment accomplished the apparatus continues in use for adjustment of the headlights. The head light alignment stand (100) is repositioned proximal the vehicle (400), approximately 2″ from the a headlight (415), to position the at least one panel (200) proximal to a headlight (415) and orthogonal to the vehicle axis (405). A position adjustment of the height and horizontal position of the panel and laser support bracket (210) will position the laser beam (387) to be co-incident with a headlight axis (420) of the headlight (415). For most headlights (415) a raised dot or depression is seen generally central to the headlight (415). The laser beam (387) will be focused on the dot or depression in the center of the head light. With the headlight (415) turned on the headlight (415) beam will shin on the panel (200).

A spot is marked, with a sticky round tab or such other marking device, on the panel (200) indicating the primary focus, which is the center focal point of the headlight (415). The head light alignment stand (100) is then repositioned distal from the vehicle by a headlight calibration distance (430) which is generally 6′, 12′ or 25′ as determined by standards J599 and J600 set by the Society of Automotive Engineers (SAE). The casters (190) are locked, the headlight (415) turned on dim with the headlight beam (425) striking the panel (200). The headlight (415) dim beam strikes the panel (200) and is then adjusted to strike the panel (200) at the indicated headlight beam calibration point (427). The indicated headlight beam calibration point (427) is 1″ drop from center and 1″ right of center at 12′ or 2″ drop and 2″ right at 25′ in accordance with the SAE standards. The headlight beam (425) is adjusted, by vehicle (400) headlight adjustment means, to strike the panel (200) at the indicated headlight beam calibration point (427) by use of headlight adjustment devices within the vehicle.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims. Various features of the invention are set forth in the appended claims.

I claim:

1. An apparatus for alignment of vehicular headlights and method of use comprising:
a headlight alignment stand (100); and
at least one panel and laser support bracket (210) affixed by slideable affixing means to the headlight alignment stand (100); and
an alignment panel (200) immovably affixed by rivet means to the panel and laser support bracket (210) and a laser system (300) immovably affixed by affixing means to the panel and laser support bracket (210); and
a laser (360) moveably affixed and positioned to direct a laser beam (387) through a panel laser aperture (240) in said panel (200) primarily orthogonal to the panel (200); and
a front level calibration device (510) positioned proximal a front vehicle wheel (410) and a rear level calibration device (520) positioned proximal a rear vehicle wheel (410); and
the headlight alignment stand (100) is positioned proximal a vehicle (400) positioning the panel primarily orthogonal to a vehicle axis (405) and aligning the laser (360) and laser beam (387) with the front level calibration device (510) and with the rear level calibration device (520); the front level calibration device (510) and the rear level calibration device (520) are primarily parallel to the vehicle axis (405); the front level calibration device (510) and the rear level calibration device (520) each having at least one level calibration line (540) equally positioned; the laser (360) and laser beam (387) is position adjusted to contact the at least one level calibration line (540) on both the front level calibration device (510) and the rear level calibration device (520); the laser (360) is temporarily immovably fixed, by laser (360) position fixing means; and
the head light alignment stand (100) is repositioned proximal the vehicle (400) to position the at least one panel (200) proximal and orthogonal to a headlight (415); adjusting the height and horizontal position of the panel and laser support bracket (210) to position the laser beam (387) to be coincident with a headlight axis (420) of the headlight (415); and
the head light alignment stand (100) is repositioned distal from the vehicle by a headlight calibration distance (430); with the headlight (415) turned on and the headlight beam (425) striking the panel (200), the headlight beam (425) is adjusted, by vehicle (400) headlight adjustment means, to strike the panel (200) at a headlight beam calibration point (427).
